(19) United States
(12) Patent Application Publication
(10) Pub. No.: US 2021/0301660 A1
(43) Pub. Date: Sep. 30, 2021

(54) CONSTRUCTION METHOD FOR MAKING WATER-RICH SAND LAYER SHIELD OVER CROSS EXISTING LINE AND UNDERNEATH CROSS SEWAGE PUSH PIPE AT CLOSE RANGE

(71) Applicants: Bridge & Tunnel Engineering Company of the Third Engineering Group Co. Ltd. of China Railway, CHENGDU (CN); China Railway No.3 Engineering Group Co., Ltd, TAIYUAN (CN)

(72) Inventors: Gangzhu LI, CHENGDU (CN); Wei LIU, CHENGDU (CN); Yapeng LI, CHENGDU (CN); Hongbo DU, CHENGDU (CN); Bole SUN, CHENGDU (CN); Xinlong ZHAO, CHENGDU (CN); Haidong WANG, CHENGDU (CN); Liang QIN, CHENGDU (CN); Xiaohui CHU, CHENGDU (CN); Bo LI, CHENGDU (CN); Qingkai LIANG, CHENGDU (CN); Xingkai SHI, CHENGDU (CN); Lei WU, CHENGDU (CN); Xiaokun LI, CHENGDU (CN); Lihao CUI, CHENGDU (CN); Zhaoxu LI, CHENGDU (CN); Xianbin DAI, CHENGDU (CN); Lanying HE, CHENGDU (CN); Shiwei ZHAN, CHENGDU (CN); Yu LIU, CHENGDU (CN)

(21) Appl. No.: 17/148,034

(22) Filed: Jan. 13, 2021

Related U.S. Application Data
(63) Continuation of application No. PCT/CN2020/120433, filed on Oct. 12, 2020.

(30) Foreign Application Priority Data
Mar. 25, 2020 (CN) 202010215957.3

(51) Int. Cl. E21D 9/06; E21D 11/10

(52) U.S. Cl. CPC E21D 9/0607; E21D 11/107

(57) ABSTRACT

The disclosure belongs to the field of tunnel construction technologies, and more particularly, relates to a construction method for making a water-rich sand layer shield over cross an existing line and underneath cross a sewage push pipe at a close range. The method specifically includes the following steps of: S1) before construction, using MIDAS GTS NX software and FLAC3D to optimize a tunneling scheme antecedently by numerical simulation to determine a part of unfavourable stress; S2) tunneling a test section, the test section being a stratum crossing a front shield direction by 45 m to 60 m; and S3) performing shield crossing construction, wherein a shield crossing construction process includes the steps of: 1) controlling a soil pressure; 2) controlling a shield thrust; 3) performing synchronous grouting; 4) performing a ballasting measure in a tunnel; and 5) performing automatic monitoring in the tunnel.

### CROSS-REFERENCE TO RELATED APPLICATIONS

This application is a continuation of International Patent Application No. PCT/CN2020/120433 with a filing date of Oct. 12, 2020, designating the United States, now pending, and further claims priority to Chinese Patent Application No. 202010215957.3 with a filing date of Mar. 25, 2020. The content of the aforementioned applications, including any intervening amendments thereto, are incorporated herein by reference.

### TECHNICAL FIELD

The disclosure belongs to the field of tunnel construction technologies, and more particularly, relates to a construction method for making a water-rich sand layer shield over cross an existing line and underneath cross a sewage push pipe at a close range.

### BACKGROUND

With development of society, with construction of a large number of urban subway tunnels and continuous improvement of a rail traffic network, many problems such as intersection of tunnel lines will emerge constantly, bringing a large number of tunnel crossing construction problems. This kind of tunnel crossing engineering problem may adversely affect an existing tunnel structure, thus affecting normal operation of an existing subway. When a shield machine crosses a pipeline, since stratum disturbance affects settlement of the pipeline, such as pipeline splitting, a safety of a surrounding environment will be extremely disadvantageously affected.

Tunnel crossing engineering comprises a newly-built tunnel underneath crossing or laterally crossing a building near a ground surface, an underneath cross and over cross existing tunnel, a tunnel underneath crossing an underground pipe network, a tunnel with a foundation pit excavated above the tunnel, and the like. According to engineering cases searched at home and abroad, most of them are cases that a shield underneath crosses the existing tunnel and the pipeline, and a supporting construction technology is also perfect. However, there is no case that the shield over crosses an operating tunnel and underneath crosses a sewage pipeline at the same time.

Moreover, under a condition of a water-rich sand layer, a stratum that a shield tunnel mainly crosses is sandy silt mixed with silty sand and sandy silt, which is weak and rich in water, poor in mechanics, and strong in water permeability. The tunnel may inevitably float up due to unloading of an upper soil body in operation, and a normal operation may be affected in the case of excessive deformation. Due to a pushing technology of a sewage push pipe, there is no foundation below the sewage push pipe, and an underneath crossing process of the shield may inevitably cause settlement. How to control a sewage push culvert above from settling and the existing tunnel below from floating up in a crossing process has become a major difficulty in the engineering.

### SUMMARY

One objective of the disclosure is to solve at least the above problem, and to provide at least the advantage to be described hereinafter.

In order to achieve the above objective, the disclosure provides a construction method for making a water-rich sand layer shield over cross an existing line and underneath cross a sewage push pipe at a close range, which comprises the following steps of: before construction, optimizing a tunneling scheme antecedently by numerical simulation to determine a part of unfavourable stress, controlling shield parameters according to the scheme in a construction process, controlling floating of an existing line through a back pressure loading ballasting in the tunnel under construction, and establishing a real-time dynamic shield parameter adjusting system according to automatic monitoring and construction monitoring data of the tunnel and a track in the existing line to adjust the shield parameters in time.

Specifically, a ballasting range of the loading ballasting is within a crossing range of the tunnel under construction and the existing line, and is within an influence area of 10 rings in front and back the crossing range of the tunnel under construction and the existing line, and the ballasting is performed by using a steel bar with φ of 100 mm and a length of 1 m; and each ring is ballasted by 4.5 t to 5 t.

Specifically, the method of the disclosure comprises the following steps of:

S1) before construction, using MIDAS GTS NX software and FLAC3D to optimize a tunneling scheme antecedently by numerical simulation to determine a part of unfavourable stress;

S2) performing shield crossing construction, the test section being a stratum crossing a front shield direction by 45 m to 60 m; and

S3) performing shield crossing construction, wherein a shield crossing construction process comprises:

1) controlling a soil pressure of an excavated face, wherein in a construction process, the soil pressure is set between 0.9 bar to 1.1 bar, and a fluctuation range of the soil pressure of tunneling in each ring is controlled within 0.1 bar;

2) controlling a shield thrust; wherein a thrusting speed is less than or equal to 40 mm/min, and thrusting is carried out by 20 cm to 30 cm per section; and a horizontal and vertical deflection angle of a shield axis is controlled within 1‰, which means that differences in horizontal and vertical directions need to be controlled within 8.5 mm;

3) performing synchronous grouting, wherein a material ratio of the synchronous grouting is 200 kg to 220 kg of cement, 300 kg to 350 kg of fly ash, 700 kg to 800 kg of sand, 100 kg to 150 kg of bentonite, and 400 kg to 450 kg of water per 1 m3 of grout, and initial setting time of the grout is 6 hours to 7 hours;

a grouting pressure and a grouting volume are controlled at the same time in the synchronous grouting to ensure the grouting pressure and give attention to the grouting volume, and the grouting pressure is controlled between 0.15 MPa and 0.25 MPa; and

4) performing automatic monitoring in the tunnel, and establishing the real-time dynamic shield parameter adjusting system based on the automatic monitoring and the construction monitoring data of the tunnel and the track in existing line.

Further, a method for controlling the soil pressure in the step S3 comprises:

calculating a soil pressure in a soil chamber by using “static soil pressure+water pressure+reserved pressure”; maintaining a dynamic balance between a water and soil pressure P in the stratum and a soil pressure PO in a sealing chamber by adjusting and controlling a soil discharge volume of a screw conveyor; controlling a mud adding volume, a jack thrusting speed, and a cutting cutter rotating speed; and obtaining a relationship between an excavated soil volume and the soil pressure as well as a relationship between a soil discharge volume and the soil pressure by actually measuring the excavated soil volume and the soil discharge volume, wherein if the excavated soil volume is greater than the soil discharge volume, the soil pressure tends to be increased; and if the excavated soil volume is less than the soil discharge volume, the soil pressure tends to be decreased.

Further, the grouting volume in the step S3 is calculated according to the following formula: Q=Vα, wherein V is a theoretical void volume, α is a filling coefficient, and Q is the grouting volume; the filling coefficient is 1.5 to 2.0, and V=π×(R1−R2)×1.2, wherein R1 is a radius of a cutter of a shield machine, and R2 is a radius of a precast reinforced concrete segment.

Further, in the step S3, when the synchronous grouting is unable to meet a settlement requirement, secondary or more supplemented grouting is performed in time; an opening of a hoisting hole of a segment is used to supplement the grout in the secondary supplemented grouting, and double-liquid grouting with a cement grout and a water glass grout is used to make up for a gap caused by hollow grout filling behind a wall, so as to prevent later settlement after tunneling, the secondary grouting is performed on a building hole behind the segment after the segment falls off from a shield tail by 5 rings.

Further, in the secondary supplemented grouting, a mass ratio of a cement grout component is that water:cement=1:1; a volume ratio of a water glass grout component is that water:water glass=2:1; a volume ratio of the cement grout to the water glass grout is 1:1; and a secondary grouting pressure is controlled between 0.2 MPa and 0.3 MPa.

Further, a method for arranging a monitoring point for the automatic monitoring in the tunnel in the step S3 comprises:

between front and rear crossing nodes of the tunnel under construction and the existing line, setting every 3 rings as a tunnel monitoring section; arranging 4 prisms in each tunnel monitoring section, comprising a set of horizontal convergence monitoring points and a set of ballast bed differential settlement monitoring points, and selecting one of the points as a roadbed settlement and horizontal displacement monitoring point.

Further, a method for measuring the automatic monitoring in the tunnel in the step S3 comprises:

an automatic monitoring system comprising a sensor, a data acquisition unit, a computer, information management software, and a communication network; automatically measuring, by various measurement control units DAU, an instrument under jurisdiction according to time set by a command of a monitoring host, converting into a digital quantity, temporarily storing the digital quantity in a measurement control unit DAU, and transmitting measured data to a host according to the command of the monitoring host; checking and monitoring, by the monitoring host, the measured data online, and transmitting checked data to a management host for storage; and processing and analyzing, by the management host, stored data, and transmitting information affecting a construction safety to competent departments at all levels.

Further, automatic real-time monitoring is performed by using a three-dimensional coordinate of a control point set in the tunnel of the existing line during monitoring, the automatic real-time monitoring is performed when a shield head of the shield of the tunnel under construction is 5 m away from the existing tunnel, and the automatic real-time monitoring is completed when a shield tail is 5 m away from the existing tunnel; a No. 1 machine of an uplink line monitors 10 rings on left and right sides of a positive influence area of the tunnel of the existing line, and every 3 rings is one monitoring section; a No. 1 machine of a downlink line monitors 10 rings on the left and right sides of the positive influence area of the tunnel of the existing line, and every 3 rings is one monitoring section; and only settlement of the ballast bed in the crossing section of the tunnel under construction and the existing tunnel and within 5 m between two sides of the crossing section is monitored in the automatic real-time monitoring.

Compared with the prior art, the advantages of the disclosure lie in that:

compared with traditional shield crossing engineering construction, the innovation lies in adopting technical measures such as finite element analysis, the automatic monitoring of the existing line, the back pressure of the steel bar in the tunnel to prevent floating, secondary grouting reinforcement, and the like, to optimize a settlement control effect of the existing line and the sewage push pipe, and an actual construction effect is remarkable. Excellent reference is provided for solving a problem that engineering construction is difficult to control when the water-rich sand layer shield crosses a risk point at a close range, and has obvious economic and social benefits and good application prospects.

### BRIEF DESCRIPTION OF THE DRAWINGS

FIG. 1 is a schematic diagram of secondary supplemented grouting.

FIG. 2 is a schematic diagram of ballasting in a tunnel.

FIG. 3 is a construction parameter diagram of a thrust and a thrusting speed in an implementation case.

FIG. 4 is a construction parameter diagram of synchronous grouting in an implementation case.

FIG. 5 is a prism distribution diagram of tunnel section monitoring.

FIG. 6 is a data analysis diagram of each monitoring item in an implementation case.

FIG. 7 is a curve graph showing settlement distribution of a ballast bed of a tunnel of an uplink line in an implementation case.

FIG. 8 is a curve graph showing settlement distribution of a ballast bed of a tunnel of a downlink line in an implementation case.

FIG. 9 is a graph showing a relationship between |p−p0| and a volume of excavated soil of a screw conveyor.
In the drawings: 1 refers to middle and upper shield segment; 2 refers to water glass injection hole; 3 refers to quick joint device for pipe fitting; 4 refers to cement grout pipe; and 5 refers to steel bar.

### DETAILED DESCRIPTION

The specific implementation manners of the disclosure are further described with reference to the accompanying drawings.

A construction method for making a water-rich sand layer shield over cross an existing line and underneath cross a sewage push pipe at a close range comprises the following steps.

In S1, before construction, MIDAS GTS NX software cooperated with FLAC3D is used to optimize a tunneling scheme antecedently by numerical simulation to determine a part of unfavourable stress.

In S2, a test section is tunneled, the test section is a stratum crossing in a front direction by 50 m; and construction parameters are adjusted and collected in the test section, and a monitoring situation is observed.

In S3, shield crossing construction is performed, wherein a shield crossing construction process comprises the following steps.

1) A soil pressure of an excavated face is controlled. In order to ensure ground settlement, maintaining a stability of the excavated face is a precondition, and the stability of the excavated face is achieved by balancing a soil pressure in a soil chamber and a soil pressure on a tunnel face. Therefore, dynamic control and management of the soil pressure on the excavated face is one of cores of a shield construction technology, and the stability of the soil pressure on the excavated face should be maintained by maintaining a balance between an excavated soil volume and a soil discharge volume in a construction process. In the construction process, the soil pressure is set between 0.9 bar to 1.1 bar, and a fluctuation range of the soil pressure of tunneling in each ring is controlled within 0.1 bar;

The soil pressure in the soil chamber is calculated by using “static soil pressure+water pressure+reserved pressure”. A dynamic balance between a water and soil pressure P in the stratum and a soil pressure PO in a sealing chamber is maintained by adjusting and controlling a soil discharge volume of a screw conveyor. A mud adding volume, a jack thrusting speed, and a cutting cutter rotating speed are controlled. A relationship between the excavated soil volume and the soil pressure as well as a relationship between the soil discharge volume and the soil pressure are obtained by actually measuring the excavated soil volume and the soil discharge volume, wherein if the excavated soil volume is greater than the soil discharge volume, the soil pressure tends to be increased; and if the excavated soil volume is less than the soil discharge volume, the soil pressure tends to be decreased.

2) A shield thrust is controlled, wherein a thrusting speed is less than or equal to 40 mm/min, and thrusting is performed by 20 cm to 30 cm per section, so as to shorten a time interval of construction-related information feedback, optimize and adjust parameters in time, and ensure a slow correction shield posture based on slow thrusting. A horizontal and vertical deflection angle of a shield axis is controlled within 1‰, which means that differences in horizontal and vertical directions need to be controlled within 8.5 mm.

3) Synchronous grouting is performed, wherein the synchronous grouting during shield crossing needs to ensure the following performances. (1) A grout has a good filling performance, which ensures that settlement after passing through of the shield machine is capable of being effectively controlled. (2) Initial setting time of the grout is appropriate, an early strength is high, and a volume shrinkage rate of the grout after hardening is small. (3) A grout consistency is appropriate, an excessively thick grout is easy to cause pipeline blockage, while an excessively thin grout is easy to cause segment floating.

A material ratio of the synchronous grouting is 200 kg to 220 kg of cement, 300 kg to 350 kg of fly ash, 700 kg to 800 kg of sand, 100 kg to 150 kg of bentonite, and 400 kg to 450 kg of water per 1 m3 of grout, and the initial setting time of the grout is 6 hours to 7 hours.

A grouting pressure and a grouting volume are controlled at the same time in the synchronous grouting, and the grouting pressure is controlled between 0.15 MPa and 0.25 MPa.

The grouting volume is calculated according to the following formula: Q=Vα, wherein V is a theoretical void volume, and α is a filling coefficient. The filling coefficient is 1.5 to 2.0, and V=π×(R1−R2)×1.2=3.102 m³, wherein R1 is a radius of a cutter of a shield machine, and R2 is a radius of a precast reinforced concrete segment.

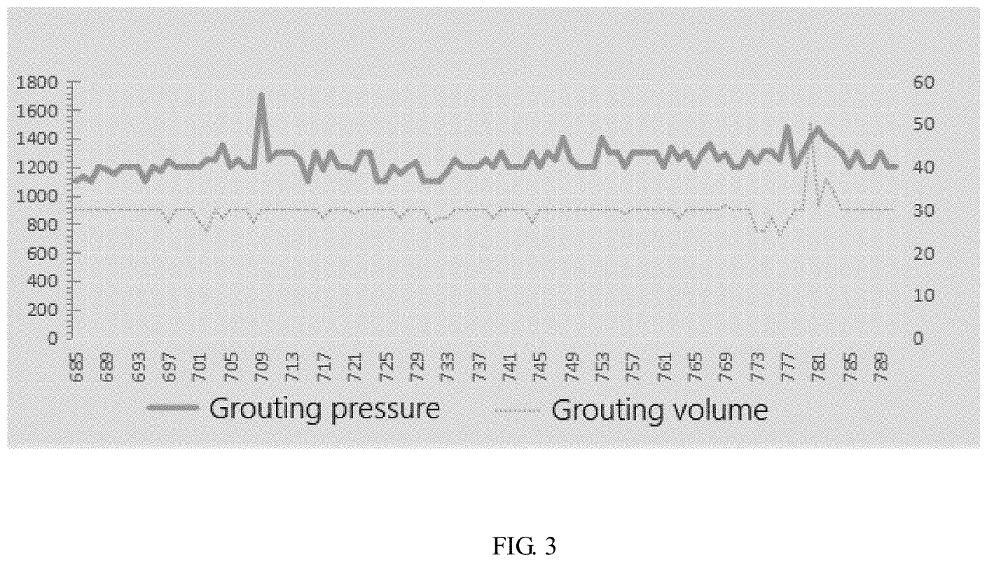

4) According to the ballasting measure in the tunnel, a loading ballasting method is used in the tunnel under construction, a ballasting range is within a crossing range of the tunnel under construction and the existing line, and is within an influence area of 10 rings in front and back the crossing range of the tunnel under construction and the existing line. The ballasting is performed by using a steel bar with φ of 100 mm and a length of 1 m. Each ring is ballasted by 78 steel bars in a total of 4.8 t, as shown in FIG. 2.

According to the method of ballasting in the tunnel under construction, not only floating of a lower tunnel of the existing line can be effectively controlled, but also floating of the tunnel under construction can be controlled, thus reducing settlement of an upper pipeline.

5) Automatic monitoring in the tunnel is performed, and the real-time dynamic shield parameter adjusting system is established based on the automatic monitoring and the construction monitoring data of the tunnel and the track in the existing line.

In the step S3, when the synchronous grouting is unable to meet a settlement requirement, secondary (or more) supplemented grouting is performed in time. An opening of a hoisting hole of a segment is used to supplement the grout in the secondary supplemented grouting, and double-liquid grouting with a cement grout and a water glass grout is used to make up for a gap caused by hollow grout filling behind a wall, so as to reduce settlement caused by incomplete synchronous grouting. In order to meet a settlement requirement of the existing line, the secondary grouting needs to be performed in construction, and a grouting position is an upper part of the segment of the tunnel, and positions and manners of supplemented grouting and injection are shown in FIG. 2. In order to prevent later settlement after tunneling, the secondary grouting is performed on a building hole behind the segment after the segment falls off from a shield tail by 5 rings.

In the secondary grouting, a ratio of a cement grout of an A liquid is water:cement=1:1 (mass ratio), a ratio of a water glass grout of a B liquid is water:water glass=2:1 (volume ratio), and A:B=1:1 (volume ratio). A secondary grouting pressure is controlled between 0.2 Mpa to 0.3 Mpa, and a principle of less injection and frequent injection is adopted. A change of the segment is greatly concerned during grouting, under main control by the pressure. Ground surface monitoring data is greatly concerned and adjusted in time.

Specifically, a method for arranging a monitoring point for the automatic monitoring in the tunnel in the step S3 comprises the following steps.

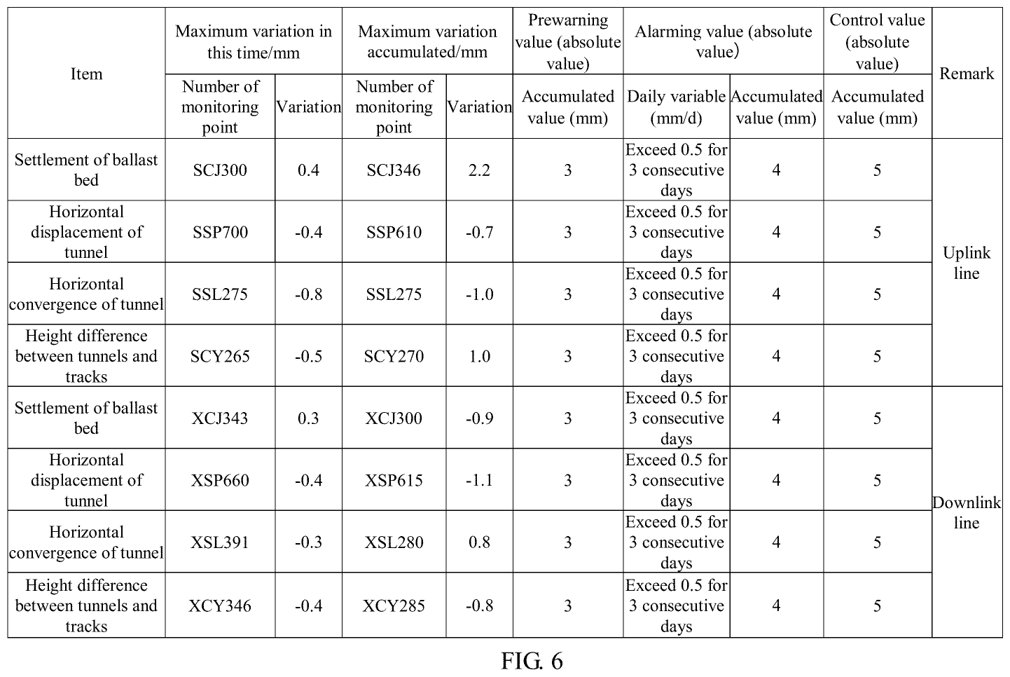

Between front and rear crossing nodes of the tunnel under construction and the existing line, every 3 rings are set as one tunnel monitoring section. 4 prisms are arranged in each tunnel monitoring section, comprising a set of horizontal convergence monitoring points and a set of ballast bed differential settlement monitoring points, and selecting one of the points as a ballast bed settlement and horizontal displacement monitoring point, as shown in FIG. 5.

Specifically, a method for measuring the automatic monitoring in the tunnel in the step S3 comprises the following steps.

An automatic monitoring system comprises a sensor, a data acquisition unit, a computer, information management software, and a communication network. An instrument under jurisdiction is automatically measured by various measurement control units DAU according to time set by a command of a monitoring host, and converted into a digital quantity, the digital quantity is temporarily stored in a measurement control unit DAU, and measured data is transmitted to a host according to the command of the monitoring host. The measured data is checked and monitored online by the monitoring host, and checked data is transmitted to a management host for storage. Stored data is mainly processed and analyzed by the management host, and information related to a safety is transmitted to competent departments at all levels.

Automatic real-time monitoring is performed by using a three-dimensional coordinate of a control point set in the tunnel of the existing line during monitoring. When a shield head of the shield of the tunnel under construction is 5 m away from the existing tunnel, and a shield tail is 5 m away from the tunnel, the automatic real-time monitoring is performed. A No. 1 machine of an uplink line monitors 10 rings on left and right sides of a positive influence area of the tunnel of the existing line, and every 3 rings is one monitoring section. A No. 1 machine of a downlink line monitors 10 rings on the left and right sides of the positive influence area of the tunnel of the existing line, and every 3 rings is one monitoring section. Only settlement of the ballast bed in the crossing section of the tunnel under construction and the existing tunnel and within 5 m between two sides of the crossing section is monitored in the automatic real-time monitoring.

### Construction Case

Taking an engineering undertaken by the applicant as an example, the engineering is located in an urban area, and a minimum clear distance between the tunnel under construction and the tunnel of the existing line is 2.987 m, which directly affects a normal operation of a subway. Meanwhile, a pipe network above the tunnel under construction here is dense, wherein a diameter of a sewage push culvert is 1200 mm, and a minimum vertical clear distance from a right line of the tunnel under construction is 1.6 m, which poses a great construction safety risk.

Before construction of the shield over cross the existing line and underneath cross the sewage push culvert at the close range, the MIDAS GTS NX software and the FLAC3D are used to optimize the tunneling scheme antecedently by numerical simulation to determine the part of unfavourable stress. In addition to controlling the above shield parameters in the construction process, the floating of the existing line is controlled by back pressure ballasting with the steel bar with φ of 100 mm and the length of 1 m in the tunnel under construction. The real-time dynamic shield parameter adjusting system is established according to automatic monitoring and construction monitoring data of the tunnel and the track in the existing line to adjust the parameters in time so as to adapt to an actual situation, and the secondary grouting is appropriately performed to strengthen a control effect. A right line of the tunnel under construction takes 11 days to over cross the existing line, and a left line of the tunnel under construction takes 11 days to over cross the existing line.

1 Construction Process Flow

Finite element analysis before tunneling→tunneling of test section→optimization of construction parameters→shield crossing construction→tunnel loading ballasting→automatic monitoring in existing tunnel→secondary grouting→unloading after stabilization→completion of crossing.

2 Operating Point

2.1 Control of Shield Construction Parameters

The construction parameters may be optimized according to a small disturbance control technology of “pushing slowly in a small section; turning slowly and evenly; and sealing the shield tail and grouting reasonably” in combination with specific circumstances. According to risk analysis, an excessively large or little positive pressure is not suitable. Therefore, according to different burying depths of the tunnel, the positive pressure should be maintained to be about 0.9 bar to 1.1 bar, and the pressure fluctuation should be maintained to be less than 0.1 bar, so as to ensure the stability of the soil body in front of a notch. A thrusting speed should be controlled to be less than or equal to 40 mm/min, and thrusting is performed by 20 cm to 30 cm per section, so as to shorten a time interval of construction-related information feedback, and optimize and adjust parameters in time. A slow correction shield posture is ensured based on slow thrusting. A horizontal and vertical deflection angle of the shield axis is controlled within 0.5‰ to 1‰, which means that differences in horizontal and vertical directions need to be controlled within 4.25 mm to 8.5 mm. A high-density grout with a consistency of 9 to 10 and a grouting volume of 5 m3 is used in the synchronous grouting, so as to improve filling and reinforcement effects of the soil body around the shield.

1. Dynamic Control of Soil Pressure on Excavated Face

In order to ensure ground settlement, maintaining a stability of the excavated face is a precondition, and the stability of the excavated face is achieved by balancing a soil pressure in a soil chamber and a soil pressure on a tunnel face. Therefore, dynamic control and management of the soil pressure on the excavated face is one of cores of a shield construction technology, and the stability of the soil pressure on the excavated face should be maintained by maintaining a balance between an excavated soil volume and a soil discharge volume in a construction process.

1) Control of Value of Soil Pressure on Excavated Face

Reasonable setting of the soil pressure is an important content of target soil pressure management. A basic principle of setting a target soil pressure for the engineering is to ensure the stability of the soil body of the excavated face and minimize an interference of tunneling to the surrounding soil body. According to a determination method of the soil pressure in the soil chamber, the soil pressure is generally calculated according to “static soil pressure+water pressure+reserved pressure”.

2) Control of Balance of Soil Pressure on Excavated Face

In order to control the stability of the excavated face, it is necessary to do a good job in dynamic management of a value of the target soil pressure, so as to maintain a dynamic balance between a water and soil pressure P in the stratum and a soil pressure PO in a sealing chamber. The balance is achieved by adjusting and controlling a soil discharge volume of a screw conveyor

As shown in FIG. 9, the soil pressure on the excavated face and a variation range thereof are important factors for the stability of the excavated face.

In order to realize the normal soil discharge of the screw conveyor and ensure the balance of the soil body of the excavated face, the management of the value of the target soil pressure also involves the mud adding volume, the jack thrusting speed, the cutting cutter rotating speed, and the like. Therefore, management of a target working pressure is actually a comprehensive management technology. The soil pressure is stabilized through adjusting the above soil pressure.

3) Management of Excavated Soil Volume

Whether a volume of excavated soil and a soil discharge volume are balanced has a great influence on the soil pressure on the excavated face. In the construction, a relationship between the excavated soil volume and the soil pressure as well as a relationship between the soil discharge volume and the soil pressure are obtained by actually measuring the excavated soil volume and the soil discharge volume, wherein if the excavated soil volume is greater than the soil discharge volume, the soil pressure tends to be increased; and if the excavated soil volume is less than the soil discharge volume, the soil pressure tends to be decreased.

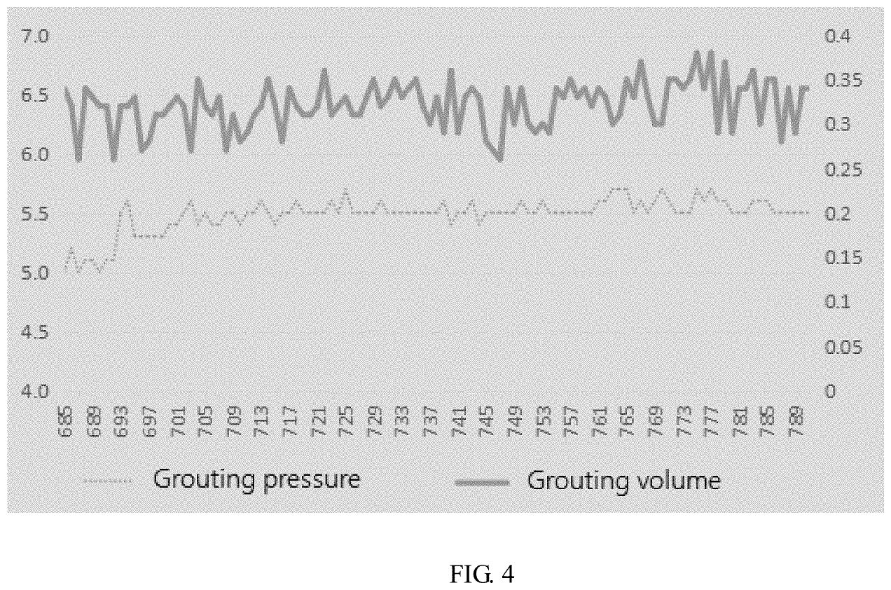

In an actual construction process, the soil pressure should be set with reference to a theoretical soil pressure and an actual strength of the soil body, and the soil pressure should be set as 0.9 bar to 0.1 bar. In the construction process, the pressure in the soil chamber should be adjusted in time according to the tunneling speed, the volume of excavated soil, a ground monitoring result, and a monitoring results of Metro Line 4, so as to avoid ground uplift and excessive settlement caused by extrusion of the reinforced soil body and over-excavation instability of the soil body, and ensure the stability of the existing line. The pressure in the soil chamber should be strictly controlled to avoid violent fluctuation of the soil pressure, and a fluctuation range of a soil pressure in tunneling by each ring should be controlled within 0.1 bar. FIG. 3 is a construction parameter diagram of a thrust and a thrusting speed.

2. Synchronous Grouting

1) Grout Ratio

The synchronous grouting during shield crossing needs to ensure the following performances. (1) A grout has a good filling performance, which ensures that settlement after passing through of the shield machine is capable of being effectively controlled. (2) Initial setting time of the grout is appropriate, an early strength is high, and a volume shrinkage rate of the grout after hardening is small. (3) A grout consistency is appropriate, an excessively thick grout is easy to cause pipeline blockage, while an excessively thin grout is easy to cause segment floating.

A material ratio of the synchronous grouting is 200 kg to 220 kg of cement, 300 kg to 350 kg of fly ash, 700 kg to 800 kg of sand, 100 kg to 150 kg of bentonite, and 400 kg to 450 kg of water per 1 m³ of grout, and the initial setting time of the grout is 6 hours to 7 hours.

2) Calculation of Grouting Volume

Generally, the calculation is performed according to the following formula: Q=Vα, wherein V is a theoretical void volume, and a is a filling coefficient.

When a diameter of a cutter of the shield machine is 6.46 m, an outer diameter of a precast reinforced concrete segment is 6.2 m, and the filling coefficient is 1.5 to 2.0, then a theoretical volume of a void between a space formed by the soil body tunneled and cut by the shield and an outer wall of the segment is:

V=π×(3.232−3.12)×1.2=3.102 m³.

Q=Vα=4.65 to 6.20 m³.

The synchronous grouting should be determined by controlling double standards of a grouting pressure and a grouting volume, and the specific grouting parameters should be adjusted as appropriate according to the ground settlement after the construction of the test section is completed.

3) Control of Grouting Volume

In a crossing process, the grouting pressure is controlled at 0.15 MPa to 0.25 MPa. Pressure control is focused and grouting volume control is supplemented during grouting. The test section is a stratum crossing in a front direction by about 50 m, and stable thrusting is endured in combination with monitoring data in a tunneling process.

4) Control of Key Grouting Technology

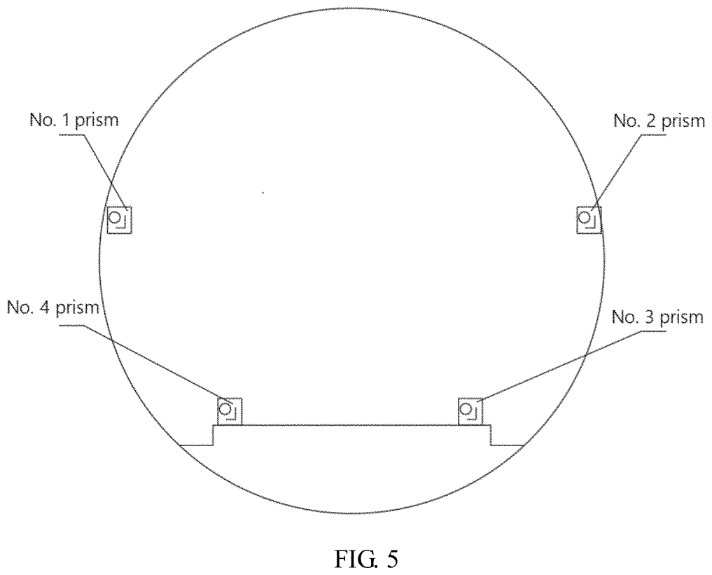

A grouting operation is a key process in shield construction, and grouting management is strengthened in construction, in strict accordance with a double guarantee principle of “ensuring the grouting pressure and taking into account the grouting volume”. The grouting operation is completed by special personnel, and it is necessary to record the grouting volume after excavation by each ring. When the grouting volume is found to be changed greatly, a reason should be carefully analyzed, and supplemented grouting is performed by increasing the grouting pressure and other methods. When the synchronous grouting cannot meet the settlement requirement, it is necessary to perform secondary (or more) grouting in time. FIG. 4 is a construction parameter table of synchronous grouting.

2.2 Bolt Fastening of Segment

The bolt fastening is a key point for segment bolt connection quality control, and a fastening torque thereof should meet a design requirement. In an assembling process of the segment by each ring, the segment is connected through a bolt while being positioned, and the bolt is fastened initially. After tunneling by a next ring, the segment falls off from the shield tail, the working face already has a fastened bolt, and at the moment, the bolt should be fastened again by the ring. In subsequent shield tunneling, before the segment is assembled by each ring, comprehensive inspection and re-fastening are performed on a connecting bolt within a range of 3 adjacent rings assembled into a ring.

2.3 Secondary Grouting

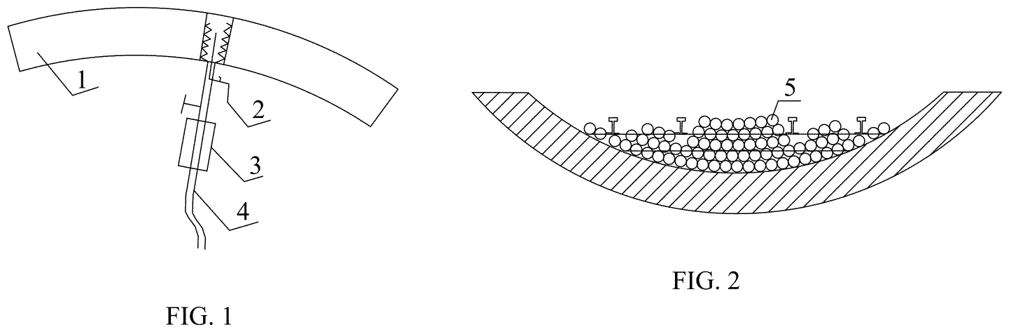

As shown in FIG. 1, an opening of a hoisting hole of a segment is used to supplement the grout in the secondary supplemented grouting, and double-liquid grouting with a cement grout and a water glass grout is used to make up for a gap caused by hollow grout filling behind a wall, so as to reduce settlement caused by incomplete synchronous grouting. In order to meet a settlement requirement of the existing line, the secondary grouting needs to be performed in construction, and a grouting position is an upper part of the segment of the tunnel. In order to prevent later settlement after tunneling, the secondary grouting is performed on a building hole behind the segment after the segment falls off from a shield tail by 5 rings.

1) Grout Ratio

Double grouts are proposed to be used for the secondary grouting.

A cement grout of an A liquid is water:cement=1:1 (mass ratio)

A water glass grout of a B liquid is water:water glass=2:1 (volume ratio)

A:B=1:1 (volume ratio)

The grouting volume of the supplemented grouting behind a wall is determined according to construction monitoring data.

2. Grouting Pressure

Since a burying depth of an upper crossing section is low, a secondary grouting pressure is controlled between 0.2 Mpa to 0.3 Mpa, and a principle of less injection and frequent injection is adopted. A change of the segment is greatly concerned in grouting, under main control of the pressure. Ground surface monitoring data is greatly concerned and adjusted in time.

2.4 Ballasting Measure in Tunnel

When the shield crosses the existing line, a loading ballasting method is adopted in the tunnel under construction. A ballasting range is within an influence area of 10 rings in front and back of a crossing range of the tunnel and the existing line. The ballasting is performed by using a steel bar with φ of 100 mm and a length of 1 m. Each ring is ballasted by 78 steel bars in a total of 4.8 t, as shown in FIG. 2.

According to the method of ballasting in the tunnel under construction, not only floating of a lower tunnel of the existing line can be effectively controlled, but also floating of the tunnel under construction can be controlled, thus reducing settlement of an upper pipeline.

2.5 Automatic Monitoring in Tunnel

1. Arrangement of Monitoring Point

A control point in the tunnel of the existing line of the subway is used to perform the automatic monitoring in the tunnel when the shield over crosses the existing line. An existing subway line has a left line (downlink) K05+133.5 to K05+231.8, a right line (uplink) K05+179.9 to K05+250.4, and every 3 rings are set as one tunnel monitoring section. A total of 46 monitoring sections are distributed on an uplink and a downlink of the crossing section. 4 prisms are arranged in each tunnel monitoring section, comprising a set of horizontal convergence monitoring points and a set of ballast bed differential settlement monitoring points, and selecting one of the points as a ballast bed settlement and horizontal displacement monitoring point, as shown in FIG. 5.

2. Measuring Method

An automatic monitoring system is generally composed of a sensor, a data acquisition unit, a computer, information management software, and a communication network. An instrument under jurisdiction is automatically measured by various measurement control units (DAU) according to time set by a command of a monitoring host, and converted into a digital quantity, the digital quantity is temporarily stored in a DAU, and measured data is transmitted to a host according to the command of the monitoring host. The measured data is checked and monitored online by the monitoring host according to a certain basis, and checked data is transmitted to a management host for storage. Stored data is mainly processed and analyzed by the management host, and information related to a safety is transmitted to competent departments at all levels.

Since the existing subway line has started to operate, the control point is set in the tunnel during construction, and automatic real-time monitoring is performed by using a three-dimensional coordinate of the control point. When a shield head of the shield in a construction line is 5 m away from the tunnel of the existing tunnel, and a shield tail is 5 m away from the tunnel, the automatic real-time monitoring is performed. A No. 1 machine of an uplink line monitors 10 rings on left and right sides of a positive influence area of a No. 4 line, and every 3 rings is one monitoring section, comprising S349 to S379, in a total of 11 sections. A No. 1 machine of a downlink line monitors a section range of X367 to X400 in real time, in a total of 12 sections. Only settlement of a ballast bed within the above range is monitored in the automatic real-time monitoring.

3. Monitoring Result

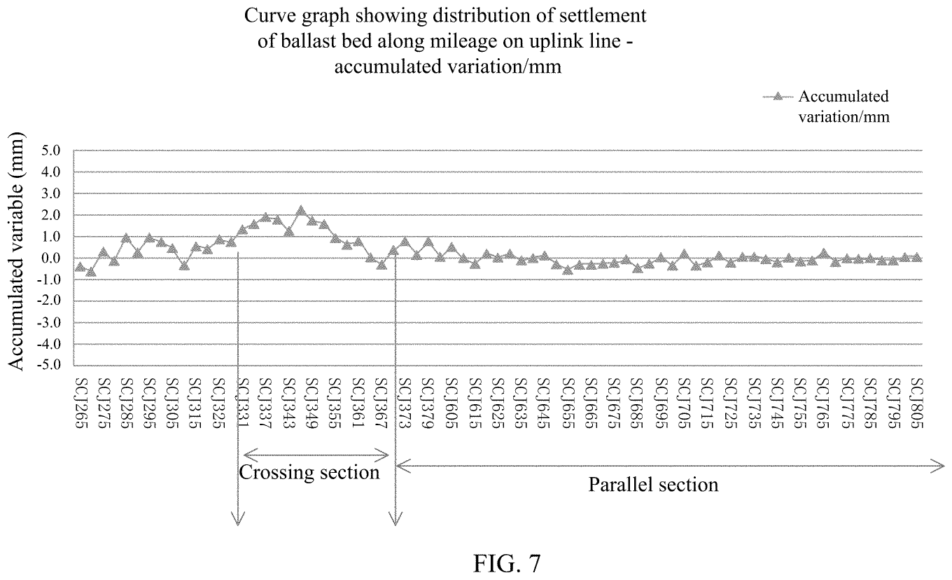

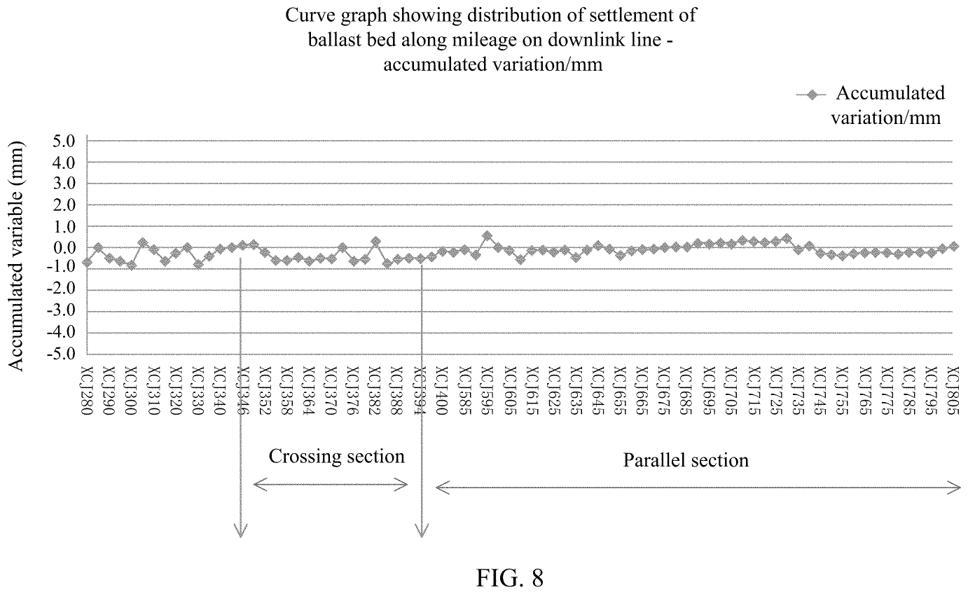

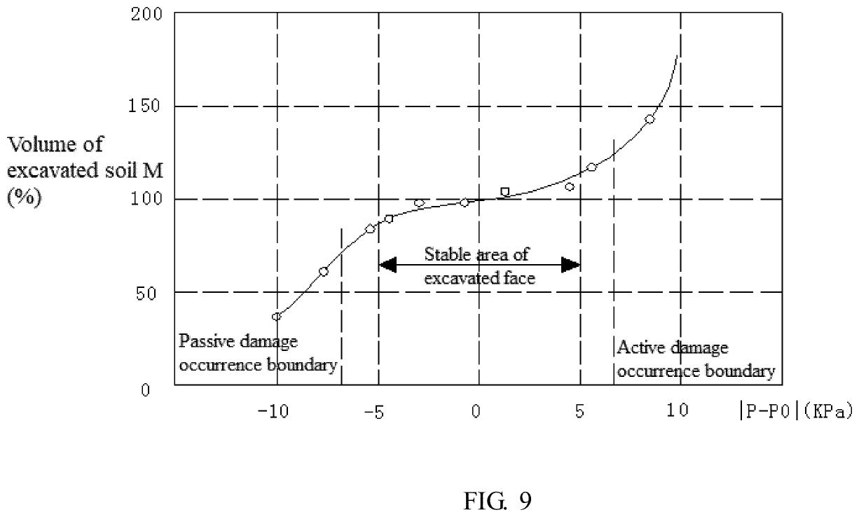

According to an automatic monitoring result of the existing line, and a maximum ballast bed settlement is 1.8 mm, a maximum horizontal displacement is 0.8 mm, which has obvious effect compared with a numerical calculation result of 7.17 mm. Up to now, a maximum accumulated settlement variation is SCJ346: +1.4 mm, a maximum accumulated horizontal displacement is XSP397: −1.0 mm, a maximum accumulated horizontal convergence is SSL590: +0.9 mm, and a maximum accumulated height difference between tracks is SCY361: +0.9 mm. FIG. 6 is a data analysis diagram of each monitoring item, FIG. 7 is a curve graph of settlement distribution of a ballast bed of a tunnel of an uplink line, and FIG. 8 is a curve graph of settlement distribution of a ballast bed of a tunnel of a downlink line.

After construction by the method of the disclosure, the existing line, the pipeline, and the ground surface are monitored, and all monitoring data are stable, and are within an allowable range of a specification. Taking the engineering undertaken by the applicant as an example, the method of the disclosure brings the following benefits.

1 Economic Benefit

Through technical measures such as the control of the shield construction parameters, the loading ballasting in the tunnel, and the automatic monitoring in the tunnel, the floating of the existing line may be effectively restrained, and the settlement of the pipeline and the settlement of the ground surface may both be within a controlled range at the same time, thus ensuring a stability and a safety of operating tunnel and pipeline. Compared with shield construction under a same condition, a lot of manpower, material resources, financial resources, and construction duration for secondary grouting and settlement treatment of the shield are saved. A direct economic benefit of the engineering is 3 Million Yuan, so that the economic benefit is remarkable.

2 Social Benefits

Through technical measures such as the control of the shield construction parameters, the loading ballasting in the tunnel, and the automatic monitoring in the tunnel, the floating of the existing line may be effectively restrained, and the settlement of the pipeline and the settlement of the ground surface may both be within a controlled range at the same time, thus ensuring a stability and a safety of operating tunnel and pipeline, accumulating experience for shield tunneling under a similar construction condition in the future, and having a broad prospect of popularization and application, so that the social benefit is obvious.

3 Energy Saving and Environmental Protection Benefits

Through technical measures such as the control of the shield construction parameters, the loading ballasting in the tunnel, and the automatic monitoring in the tunnel, the floating of the existing line may be effectively restrained, and the settlement of the pipeline and the settlement of the ground surface may both be within a controlled range at the same time, thus ensuring a stability and a safety of operating tunnel and pipeline, avoiding pollution and damage to a surrounding environment in a shield construction process, and greatly reducing an influence on production and life of surrounding people, so that better environmental protection and energy saving benefits are achieved.

We claim:

1. A construction method for making a water-rich sand layer shield over cross an existing line and underneath cross a sewage push pipe at a close range, comprising the steps of: before construction, optimizing a tunneling scheme antecedently by numerical simulation to determine a part of unfavourable stress, controlling shield parameters according to the scheme in a construction process, controlling floating of an existing line through a back pressure loading ballasting in the tunnel under construction, and establishing a real-time dynamic shield parameter adjusting system according to automatic monitoring and construction monitoring data of the tunnel and a track in the existing line to adjust the shield parameters, wherein a ballasting range of the loading ballasting is within a crossing range of the tunnel under construction and the existing line, and is within an influence area of 10 rings in front and back the crossing range of the tunnel under construction and the existing line, and the ballasting is performed by using a steel bar with φ of 100 mm and a length of 1 m; and each ring is ballasted by 4.5 t to 5 t.

2. The construction method for making a water-rich sand layer shield over cross an existing line and underneath cross a sewage push pipe at a close range according to claim 1, specifically comprising the following steps of:
S1) before construction, using MIDAS GTS NX software and FLAC3D to optimize a tunneling scheme antecedently by numerical simulation to determine a part of unfavourable stress;
S2) performing shield crossing construction, the test section being a stratum crossing a front shield direction by 45 m to 60 m; and
S3) performing shield crossing construction, wherein a shield crossing construction process comprises:
1) controlling a soil pressure of an excavated face, wherein in a construction process, the soil pressure is set between 0.9 bar to 1.1 bar, and a fluctuation range of the soil pressure of tunneling in each ring is controlled within 0.1 bar;
2) controlling a shield thrust; wherein a thrusting speed is less than or equal to 40 mm/min, and thrusting is performed by 20 cm to 30 cm per section; and a horizontal and vertical deflection angle of a shield axis is controlled within 1‰, which means that differences in horizontal and vertical directions need to be controlled within 8.5 mm;
3) performing synchronous grouting, wherein a material ratio of the synchronous grouting is 200 kg to 220 kg of cement, 300 kg to 350 kg of fly ash, 700 kg to 800 kg of sand, 100 kg to 150 kg of bentonite, and 400 kg to 450 kg of water per 1 m³ of grout, and initial setting time of the grout is 6 hours to 7 hours;
a grouting pressure and a grouting volume are controlled at the same time in the synchronous grouting to ensure the grouting pressure and give attention to the grouting volume, and the grouting pressure is controlled between 0.15 MPa and 0.25 MPa; and
4) performing automatic monitoring in the tunnel, and establishing the real-time dynamic shield parameter adjusting system based on the automatic monitoring and the construction monitoring data of the tunnel and the track in existing line.

3. The construction method for making a water-rich sand layer shield over cross an existing line and underneath cross a sewage push pipe at a close range according to claim 2, wherein a method for controlling the soil pressure in the step S3 comprises:
calculating a soil pressure in a soil chamber by using “static soil pressure+water pressure+reserved pressure”; maintaining a dynamic balance between a water and soil pressure P in the stratum and a soil pressure PO in a sealing chamber by adjusting and controlling a soil discharge volume of a screw conveyor; controlling a mud adding volume, a jack thrusting speed, and a cutting cutter rotating speed; and obtaining a relationship between an excavated soil volume and the soil pressure as well as a relationship between a soil discharge volume and the soil pressure by actually measuring the excavated soil volume and the soil discharge volume, wherein if the excavated soil volume is greater than the soil discharge volume, the soil pressure tends to be increased; and if the excavated soil volume is less than the soil discharge volume, the soil pressure tends to be decreased.

4. The construction method for making a water-rich sand layer shield over cross an existing line and underneath cross a sewage push pipe at a close range according to claim 2, wherein the grouting volume in the step S3 is calculated according to the following formula: Q=Vα, wherein V is a theoretical void volume, a is a filling coefficient, and Q is the grouting volume; the filling coefficient is 1.5 to 2.0, and V=π×(R1−R2)×1.2, wherein R1 is a radius of a cutter of a shield machine, and R2 is a radius of a precast reinforced concrete segment.

5. The construction method for making a water-rich sand layer shield over cross an existing line and underneath cross a sewage push pipe at a close range according to claim 2, wherein in the step S3, when the synchronous grouting is unable to meet a settlement requirement, secondary or more supplemented grouting is performed in time; an opening of a hoisting hole of a segment is used to supplement the grout in the secondary supplemented grouting, and double-liquid grouting with a cement grout and a water glass grout is used to make up for a gap caused by hollow grout filling behind a wall, so as to prevent later settlement after tunneling, the secondary grouting is performed on a building hole behind the segment after the segment falls off from a shield tail by 5 rings.

6. The construction method for making a water-rich sand layer shield over cross an existing line and underneath cross a sewage push pipe at a close range according to claim 5, wherein in the secondary supplemented grouting, a mass ratio of a cement grout component is that water:cement=1:1; a volume ratio of a water glass grout component is that water:water glass=2:1; a volume ratio of the cement grout to the water glass grout is 1:1; and a secondary grouting pressure is controlled between 0.2 MPa and 0.3 MPa.

7. The construction method for making a water-rich sand layer shield over cross an existing line and underneath cross a sewage push pipe at a close range according to claim 2, wherein a method for arranging a monitoring point for the automatic monitoring in the tunnel in the step S3 comprises:
between front and rear crossing nodes of the tunnel under construction and the existing line, setting every 3 rings as a tunnel monitoring section; arranging 4 prisms in each tunnel monitoring section, comprising a set of horizontal convergence monitoring points and a set of ballast bed differential settlement monitoring points, and selecting one of the points as a ballast bed settlement and horizontal displacement monitoring point.

8. The construction method for making a water-rich sand layer shield over cross an existing line and underneath cross a sewage push pipe at a close range according to claim 2, wherein a method for measuring the automatic monitoring in the tunnel in the step S3 comprises:
an automatic monitoring system comprising a sensor, a data acquisition unit, a computer, information management software, and a communication network; automatically measuring, by various measurement control units DAU, an instrument under jurisdiction according to time set by a command of a monitoring host, converting into a digital quantity, temporarily storing the digital quantity in a measurement control unit DAU, and transmitting measured data to a host according to the command of the monitoring host; checking and monitoring, by the monitoring host, the measured data online, and transmitting checked data to a management host for storage; and processing and analyzing, by the management host, stored data, and transmitting information affecting a construction safety to competent departments at all levels.

9. The construction method for making a water-rich sand layer shield over cross an existing line and underneath cross a sewage push pipe at a close range according to claim 8, wherein automatic real-time monitoring is performed by using a three-dimensional coordinate of a control point set in the tunnel of the existing line during monitoring, the automatic real-time monitoring is performed when a shield head of the shield of the tunnel under construction is 5 m away from the existing tunnel, and the automatic real-time monitoring is completed when a shield tail is 5 m away from the existing tunnel; a No. 1 machine of an uplink line monitors 10 rings on left and right sides of a positive influence area of the tunnel of the existing line, and every 3 rings is one monitoring section; a No. 1 machine of a downlink line monitors 10 rings on the left and right sides of the positive influence area of the tunnel of the existing line, and every 3 rings is one monitoring section; and only settlement of the ballast bed in the crossing section of the tunnel under construction and the existing tunnel and within 5 m between two sides of the crossing section is monitored in the automatic real-time monitoring.
